(19) United States
(12) Patent Application Publication
(10) Pub. No.: US 2024/0128729 A1
(43) Pub. Date: Apr. 18, 2024

(54) Junction Box and Method For Manufacturing the Same

(71) Applicant: Tyco Electronics (Shanghai) Co., Ltd., Shanghai (CN)

(72) Inventors: Guoqiang (David) Li, Shanghai (CN); Yong (Chris) Wang, Shanghai (CN); Jianfei (Fencer) Yu, Shanghai (CN); Yong Yang, Shanghai (CN)

(73) Assignee: Tyco Electronics (Shanghai) Co., Ltd., Shanghai (CN)

(21) Appl. No.: 18/485,731

(22) Filed: Oct. 12, 2023

(30) Foreign Application Priority Data
Oct. 14, 2022 (CN) 202211261536.X

(51) Int. Cl. H02G 3/08

(52) U.S. Cl. CPC H02G 3/081; H02G 3/088

(57) ABSTRACT

A junction box includes a box body, a connector core, and a connector housing. The connector core is integrally molded with the box body. The connector housing is formed separately from the box body and the connector core and is embedded within the box body during molding of the box body and the connector core.

### CROSS-REFERENCE TO RELATED APPLICATION

This application claims the benefit of Chinese Patent Application No. CN202211261536.X filed on Oct. 14, 2022, in the State Intellectual Property Office of China, the whole disclosure of which is incorporated herein by reference.

### FIELD OF THE INVENTION

The present invention relates to a junction box and a method for manufacturing the junction box.

### BACKGROUND

A junction box according to the prior art typically includes a box body, a connector, and a light guide post. A connector installation hole and a light guide post installation hole are formed in the box body. The connector is assembled in the connector installation hole on the box body. The light guide post is assembled in the light guide post installation hole on the box body. A connector usually includes a connector housing, a connector core, and a connector terminal. The connector core is installed in the connector housing, and the connector terminal is installed in the connector core.

In a process of producing this junction box, it is necessary to separately manufacture the box body, light guide post, connector housing, connector core and connector terminal, and then assemble the various components produced together to form the junction box. Usually, assembling the junction box requires completing multiple steps. These steps may include 1) installing the connector core into the connector housing; 2) installing the connector terminal into the connector core; 3) installing the connector into the connector installation hole on the box body; and 4) installing the light guide post into the light guide post installation hole on the box body. In addition, in order to achieve a waterproof assembly, is necessary to form injection grooves for accommodating sealant on some components of the junction box. Then, after completing the assembly of various components of the junction box, sealant must be placed (e.g., poured) into the injection groove to seal the gaps between the components.

Accordingly, the manufacturing process of a junction box according to the prior art is complex and cumbersome, which leads to very low manufacturing efficiency and high manufacturing costs.

### SUMMARY

According to an embodiment of the present disclosure, a junction box includes a box body, a connector core, and a connector housing. The connector core is integrally molded with the box body. The connector housing is formed separately from the box body and the connector core and is embedded within the box body during molding of the box body and the connector core.

### BRIEF DESCRIPTION OF THE DRAWINGS

The invention will now be described by way of example with reference to the accompanying Figures, of which:

FIG. 1 is an illustrative perspective view of a junction box according to an exemplary embodiment of the present invention;

FIG. 2 is an illustrative perspective view of a connector housing of a junction box according to an exemplary embodiment of the present invention;

FIG. 3 is an illustrative perspective view of a light guide post of a junction box according to an exemplary embodiment of the present invention; and

FIG. 4 is an illustrative perspective view of a connector terminal of a junction box according to an exemplary embodiment of the present invention.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a method for manufacturing a junction box includes the steps of providing a connector housing and a light guide post, and simultaneously forming a box body and a connector core with a terminal hole by an embedded injection molding process. During the injection molding process, the connector housing and the light guide post are embedded components, such that the connector housing is directly integrated to the box body and the connector core, and the light guide post is directly integrated to the box body.

According to another embodiment of the present disclosure, another method for manufacturing a junction box includes the steps of providing a connector housing, and simultaneously forming a box body with a light guide post hole and a connector core with a terminal hole by an embedded injection molding process. In this molding process, the connector housing is an embedded component, such that the connector housing is directly integrated to the box body and the connector core.

According to another embodiment of the present disclosure, another method for manufacturing a junction box includes the steps of providing a connector housing, simultaneously forming a box body with a light guide post hole and a connector core with a terminal hole and providing a light guide post. The formation of the box body is achieved by an embedded injection molding process in which the connector housing is an embedded component, such that the connector housing is directly integrated to the box body and the connector core. The step of providing the light guide post includes assembling the light guide post into the light guide post hole on the box body.

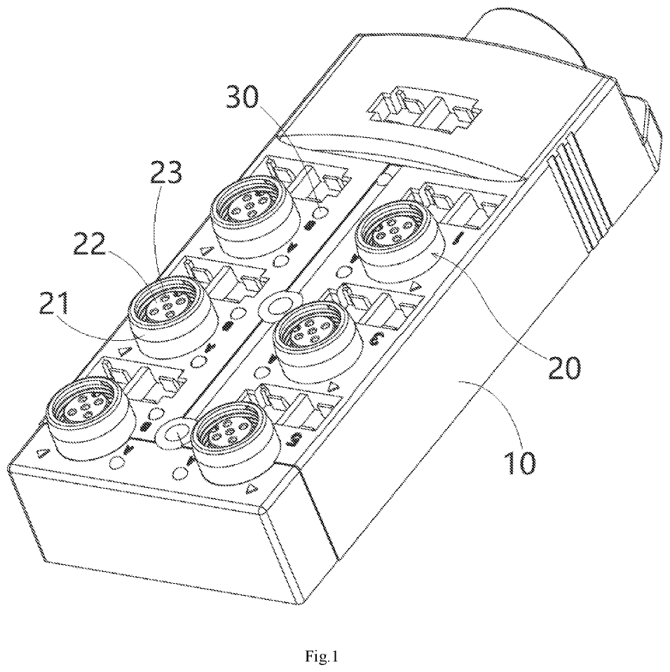

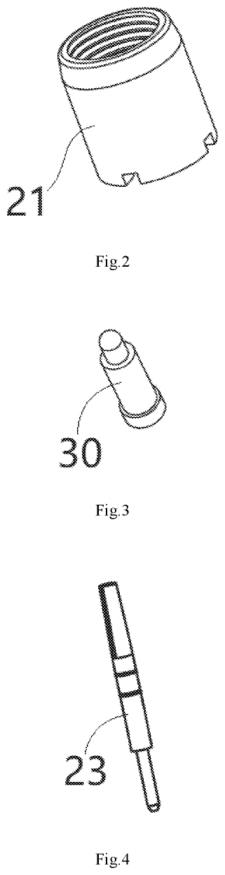

FIG. 1 is an illustrative perspective view of a junction box according to an exemplary embodiment of the present invention. FIG. 2 is an illustrative perspective view of the connector housing 21 of a junction box according to an exemplary embodiment of the present invention. FIG. 3 is an illustrative perspective view of the light guide post 30 of a junction box according to an exemplary embodiment of the present invention. FIG. 4 is an illustrative perspective view of connector terminal 23 of a junction box according to an exemplary embodiment of the present invention.

The following description will refer to FIGS. 1-4 to provide a detailed explanation of three different embodiments for manufacturing the junction box.

In the first embodiment of the present invention, a method for manufacturing a junction box is disclosed. The method for manufacturing this junction box mainly includes the steps of: S11: providing a connector housing 21 and a light guide post 30; and S12: simultaneously forming a box body 10 and a connector core 22 with a terminal hole by an embedded injection molding process in which the connector housing and light guide post define embedded components, such that the connector housing is directly integrated to the box body and connector core, and the light guide post is directly integrated to the box body.

In this way, the prior art steps of installing the connector housing 21, installing the connector core 22, and installing the light guide post 30 can be omitted. Likewise, the steps of injecting sealant between the connector housing 21 and the box body 10, between the connector core 22 and the connector housing, and between the light guide post 30 and the box body can also be omitted. Therefore, the present invention greatly simplifies the manufacturing process of the junction box, improves the manufacturing efficiency of the junction box, and reduces the manufacturing cost of the junction box.

The aforementioned junction box manufacturing method further comprises the step of: S13: providing a connector terminal 23 and assembling the connector terminal into the terminal hole on connector core 22. According to an embodiment, the connector housing 21 can be a machined component, the light guide post 30 can be an injection molded component, and the connector terminal 23 can be a machined or stamped component.

Still referring to the first embodiment of the present disclosure, a junction box is also disclosed. The junction box includes the box body 10, the connector housing 21, the connector core 22, and the light guide post 30. In the illustrated embodiment, the box body 10, connector housing 21, connector core 22, and light guide post 30 are formed into an integral component by an embedded injection molding process. During the injection molding process, the connector housing 21 and the light guide post 30 are embedded components, while the box body 10 and the connector core 22 are injection molded components.

The connector core 22 has a terminal hole. The junction box also includes the connector terminal 23 installed in the terminal hole. In the illustrated embodiment, the connector housing 21, the connector core 22, and the connector terminal 23 form a connector 20 integrated to the box body 10. In the illustrated embodiment, the junction box has multiple connectors 20 and multiple light guide posts 30.

In the second embodiment of the present invention, a method for manufacturing a junction box is disclosed. The method of manufacturing this junction box includes the steps of: S21: providing a connector housing 21; and S22: simultaneously forming a box body 10 with a light guide post hole and a connector core 22 with a terminal hole by an embedded injection molding process in which the connector housing is realized as the embedded component, such that the connector housing is directly integrated to the box body and the connector core.

The aforementioned junction box manufacturing method also includes a step of: S23: forming a light guide post 30 in the light guide post hole on the box body 10 by a double injection molding process, so that the light guide post is directly integrated to the box body. In this way, the steps of installing the connector housing 21, installing the connector core 22, and installing the light guide post 30 can be omitted. Likewise, the steps of injecting sealant between the connector housing 21 and the box body 10, between the connector core 22 and the connector housing 21, and between the light guide post 30 and the box body can also be omitted. In this way, the present invention greatly simplifies the manufacturing process of the junction box, improves the manufacturing efficiency of the junction box, and reduces the manufacturing cost of the junction box.

The aforementioned junction box manufacturing method further comprises a step of: S24: providing a connector terminal 23 and assembling it into the terminal hole on connector core 22. In the second embodiment of the present invention, the connector housing 21 can be a machined component, and the connector terminal 23 can be a machined or stamped component.

Still referring to the second embodiment of the present invention, a junction box is also disclosed. The junction box includes the box body 10, the connector housing 21, and the connector core 22. The box body 10, connector housing 21, and connector core 22 are formed into an integral component by an embedded injection molding process in which the connector housing is an embedded component, and the box body and connector core are injection molded components.

In the second embodiment of the present invention, the box body 10 has a light guide post hole. The junction box also includes a light guide post 30 that is formed in the light guide post hole by a dual injection molding process (e.g., molded concurrently with the box body and connector core). The connector core 22 has a terminal hole, and the junction box also includes a connector terminal 23 installed in the terminal hole. In the illustrated embodiment, the connector housing 21, the connector core 22, and the connector terminal 23 form a connector 20 integrated to the box body 10. In the illustrated embodiment, the junction box has multiple connectors 20 and multiple light guide posts 30.

In the third embodiment of the present invention, a method for manufacturing a junction box is disclosed. The method includes the steps of: S31: providing a connector housing 21; S32: simultaneously forming a box body 10 with a light guide post hole and a connector core 22 with a terminal hole by an embedded injection molding process in which the connector housing 21 is used as the embedded component, so that the connector housing is directly integrated to the box body and the connector core; and S33: providing the light guide post 30 and assembling it into the light guide post hole on the box body.

In this way, the steps of installing the connector housing 21 and the connector core 22 can be omitted, and the steps of injecting sealant between the connector housing and the box body 10, as well as between the connector core and the connector housing, can also be omitted. In this way, the present invention greatly simplifies the manufacturing process of the junction box, improves the manufacturing efficiency of the junction box, and reduces the manufacturing cost of the junction box.

In the third embodiment of the present invention, the aforementioned junction box manufacturing method further comprises a step of: S34: providing a connector terminal 23 and assembling it into the terminal hole on connector core 22. The connector housing 21 can be a machined component, the light guide post 30 can be an injection molded component, and the connector terminal 23 can be a machined or stamped component.

A junction box according to the third embodiment of the present invention is also disclosed. The junction box includes the box body 10, the connector housing 21, and the connector core 22. In this embodiment, the box body 10, connector housing 21, and connector core 22 are formed into an integral component by an embedded injection molding process. During the embedded injection molding process, the connector housing 21 is provided as an embedded component, while the box body 10 and connector core 22 are injection molded components.

In the third embodiment of the present invention, the box body 10 has a light guide post hole, and the junction box also includes a light guide post 30 installed in the light guide post hole. The connector core 22 has a terminal hole, and the junction box also includes a connector terminal 23 installed in the terminal hole. In the illustrated embodiment, the connector housing 21, the connector core 22, and the connector terminal 23 form the connector 20 integrated to the box body 10. In the illustrated embodiment, the junction box has multiple connectors 20 and multiple light guide posts 30.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A junction box, comprising:
a box body;
a connector core integrally molded with the box body; and
a connector housing formed separately from the box body and the connector core and embedded within the box body during molding of the box body and the connector core.

2. The junction box according to claim 1, further comprising a connector terminal arranged within a terminal hole defined in the connector core, the connector housing, the connector core and the connector terminal form a connector that is integral to the box body.

3. The junction box according to claim 2, further comprising a light guide post.

4. The junction box according to claim 3, wherein the light guide post is formed separately from the box body and the connector core.

5. The junction box according to claim 4, wherein the light guide post is embedded within the box body during the molding of the box body and the connector core.

6. The junction box according to claim 4, wherein the box body defines a molded light guide post hole.

7. The junction box according to claim 6, wherein the light guide post is inserted into the light guide post hole during assembly of the junction box.

8. The junction box according to claim 3, wherein the light guide post is molded during the molding of the box body and the connector core.

9. The junction box according to claim 3, wherein the connector housing is a machined component, the light guide post is an injection molded component, and the connector terminal is a machined or stamped component.

10. A junction box, comprising:
a box body;
a connector core integrally molded with the box body;
a connector housing formed separately from the box body and the connector core and embedded within the box body during molding of the box body and the connector core; and
a light guide post formed separately from the box body and the connector core and embedded within the box body during molding of the box body and the connector core.

11. A method for manufacturing a junction box comprising steps of:
providing a connector housing; and
simultaneously forming a box body and a connector core by an embedded injection molding process in which the connector housing is an embedded component such that the connector housing is directly integrated to the box body and the connector core.

12. The method according to claim 11, wherein the step of forming the box body and the connector core includes forming a terminal hole in the connector core.

13. The method according to claim 12, further comprising steps of:
providing a connector terminal; and
inserting the connector terminal into the terminal hole after the formation of the box body and the connector core.

14. The method of according to claim 11, further comprising the step of providing a light guide post.

15. The method of according to claim 14, wherein the light guide post is embedded within the box body during the molding of the box body and the connector core.

16. The method of according to claim 14, wherein the step of forming the box body includes forming a molded light guide post hole.

17. The method of according to claim 16, further comprising a step of inserting the light guide post into the light guide post hole.

18. The method according to claim 16, wherein the light guide post is formed in the light guide post hole by a dual injection molding process.

19. The method of according to claim 18, wherein the light guide post is molded during the molding of the box body and the connector core.

20. The method according to claim 14, wherein the connector housing is a machined component and the light guide post is an injection molded component.
